(19) United States
(12) Patent Application Publication
(10) Pub. No.: US 2008/0243552 A1
(43) Pub. Date: Oct. 2, 2008

(54) DRUG INFORMATION COLLECTING NETWORK SYSTEM AND ELECTRONIC CHART APPARATUS

(75) Inventor: Masaru ASAKAWA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/058,683

(22) Filed: Mar. 29, 2008

(30) Foreign Application Priority Data
Mar. 29, 2007 (JP) 2007-089610

(51) Int. Cl. G06F 19/00; G06Q 50/00

(52) U.S. Cl. 705/3

(57) ABSTRACT

An electronic chart system consists of terminal apparatuses and a common database. The common database is provided with a chart data storage storing chart data of individual patients, a drug information storage storing recognized information on approved drugs and an administration result storage storing information on such results from administration of some drugs that were unexpected when the drugs were approved. The terminal apparatus is provided with an administration result entry section for entering the unexpected results of administration. As the unexpected administration result is entered, the administration result entry section records it in the administration result storage in association with chart data of the patients who get the unexpected results, and also sends the unexpected result together with the chart data to a data center.

### FIELD OF THE INVENTION

The present invention relates to a network system for collecting drug information and an electronic chart apparatus.

### BACKGROUND OF THE INVENTION

Any drugs to be prescribed for patients should get official approvals through drug trials and researches. The drug trial is a clinical investigation of a drug asking for approval from the authorities. If there are variations in procedure of collecting results of drug trials, including drugs' effects and side-effects, from one doctor to another, it is not possible to ensure the reliability and objectivity of the results of drug trials. Japanese Laid-open Patent Application No. 2002-095641 discloses a clinical trial support system which supports the clinical trial so that the clinical trial is appropriately executed in accordance with predetermined methods and procedures. The clinical trial support system timely gives appropriate indications from a host computer to doctors who are going to report the results of drug trials, so that highly reliable and objective results of drug trials can be collected.

Thus, the drugs are going to be sold after being approved through the drug trials and researches. On the practical use, however, the approved drugs sometimes produce different results, effects or side-effects, from initially expected ones. Moreover it often takes time to become aware of probability of cause-and-effect relationship between an approved drug and an initially unexpected result of administration of the approved drug. When the unexpected results are good ones, there is no problem. When the unexpected results include bad side-effects, however, the delay of discovery of the cause-and-effect relationship might cause serious problems. Conventional trial support systems are not directed to collect the results of administration of the approved drugs and the like, so it has been desired to take some measures for it.

### SUMMARY OF THE INVENTION

In view of the foregoing problems, an object of the present invention is to provide a drug information collecting network system which can easily and swiftly collect the results of administration of the approved drugs, and an electronic chart apparatus used for the network system.

A drug information collecting network system of the present invention comprises a drug information collecting apparatus and at least an electronic chart apparatus connected to the drug information collecting apparatus through a communication network. The electronic chart apparatus computerizes and manages medical charts of patients, and comprises a communication device for sending data to the drug information collecting apparatus through the communication network, and an administration result entry device for entering results of administration of prescribed drugs in the medical charts, wherein such results of administration of the prescribed drugs that were unexpected when the prescribed drugs were approved are sent from the administration result entry device to the drug information collecting apparatus in association with the medical charts of respective patients who get the unexpected administration results.

Preferably, the electronic chart apparatus further comprises a storage device for storing and accumulating the unexpected results of administration of the prescribed drugs as entered through the administration result entry device; a search device for searching the storage device for similar cases to an unexpected result of administration; and a judging device for judging based on data obtained by the search device whether the unexpected result of administration should be sent to the drug information collecting apparatus.

The judging device preferably judges that the unexpected result of administration should be sent to the drug information collecting apparatus if the search device retrieves more than a given number of similar cases from the storage device.

According to the drug information collecting network system of the present invention, the electronic chart apparatus is provided with a function to enter results of administration of approved drugs and send the entered results of administration to the drug information collecting apparatus, so that the results of administration of the approved drugs will be promptly and efficiently collectable. Sending the results of administration in association with the medical charts of the respective patients helps research and investigation of these results.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory diagram illustrating a drug information collecting network system;

FIG. 2 is an explanatory diagram illustrating an electronic chart system;

FIG. 3 is an explanatory diagram illustrating a medical chart input screen;

FIG. 4 is an explanatory diagram illustrating a report input screen;

FIG. 5 is an explanatory diagram illustrating reported data;

FIG. 6 is a flowchart illustrating a sequence of procedures for accepting a reported result of administration;

FIG. 7 is an explanatory diagram illustrating an embodiment wherein an administration result receptor is provided with an adequacy judging section;

FIG. 8 is an explanatory diagram illustrating a detail input screen; and

FIG. 9 is a flowchart illustrating a sequence of procedures in a terminal apparatus, including adequacy judgment.

### DESCRIPTION OF THE PREFERRED EMBODIMENTS

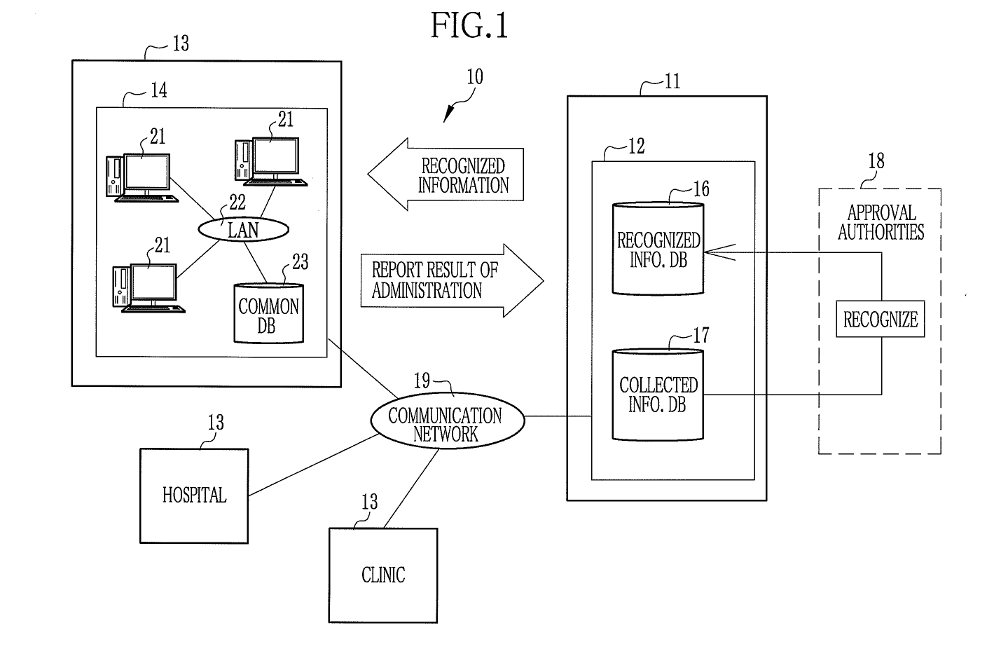

As shown in FIG. 1, a drug information collecting network system 10 consists of a drug information system 12 placed in a data center 11 and an electronic chart system 14 placed in such medical facilities as a hospital 13. The drug information system 12 has recognized information DB (database) 16 and a collected information DB (database) 17. The recognized information DB 16 is a storage section storing information on approved drugs that have gone through the drug trials and gained approval from approval authorities 18. The collected information DB 17 is a collected information storage section for storing results of administration of the approved drugs reported after the drug trial from the respective hospitals 13. The recognized information DB 16 and the collected information DB 17 are connected to the electronic chart system 14 through a communication network 19 so that they can communicate with each other. The data center 11, which is for example managed by a drug maker or an information service company, delivers information on the approved drugs to respective hospitals 13 and collects information on the approved drugs from the hospitals 13.

The electronic chart system 14 accesses the recognized information DB 16 to download the information on approved drugs. The information on approved drugs is used by doctors to prescribe drugs. When administration of the prescribed drug produces a result that was not expected in the initial stage of approval of the prescribed drug, the result of administration is input to the electronic chart system 14. Then the electronic chart system 14 uploads the result of administration to the collected information DB 17. The data center 11 reviews the collected information to examine the drug in question, and submits the information to the approval authorities 18. The approval authorities 18 confirm the information and store it in the recognized information DB 16 if the information is recognized as proper information on the approved drug.

The electronic chart system 14 consists of plural terminal apparatuses 21 and a common DB 23 accessibly connected to the respective terminal apparatuses 21 through a LAN 22. The terminal apparatus 21 is arranged for example in each department of each hospital 13 and operated by a doctor or a nurse. The common DB 23 stores for example the information on the approved drugs downloaded from the recognized information DB 16 and the results of administration input through the respective terminal apparatuses 21.

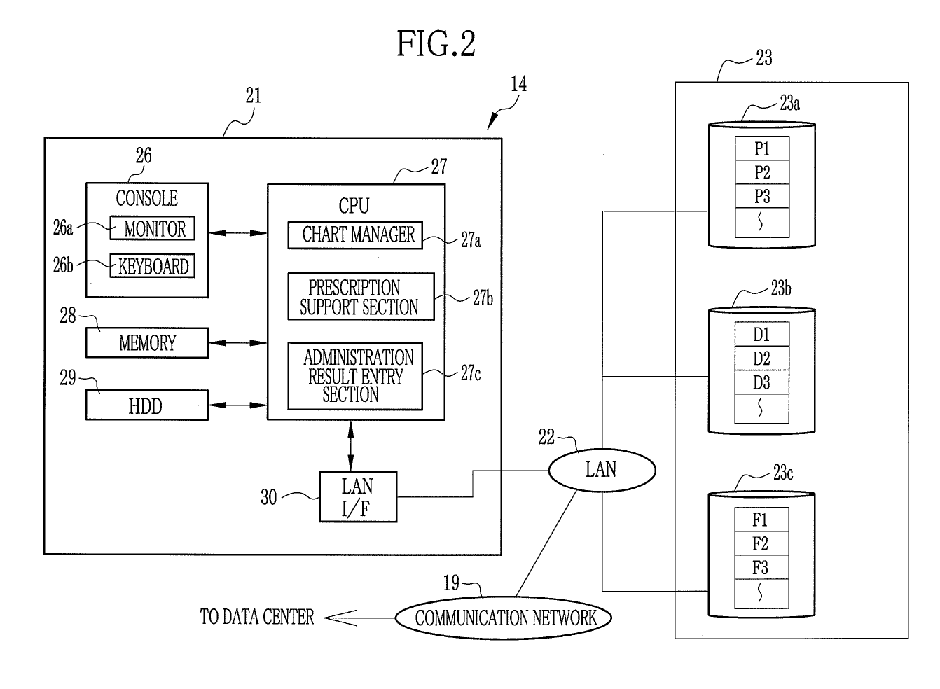

As shown in FIG. 2, the common DB 23 consists of a chart data storage 23a storing medical chart data of every patient (P1, P2, P3 . . . ), a drug information storage 23b storing drug information on every drug (D1, D2, D3 . . . ) downloaded from the recognized information DB 16, and an administration result storage 23c storing the results of administration (F1, F2, F3 . . . ) to be uploaded onto the collected information DB 17.

The terminal apparatus 21 is based on, for example, a personal computer or a workstation, which is installed with a control program as an operating system and an electronic chart program as an application program and provided with a console 26, a CPU 27, a memory 28, a Hard Disk Drive (HDD) 29 and a LAN interface 30.

As the electronic chart program starts up, the CPU 27 controls the overall operation of every part of the terminal apparatus 21 with running the control program and also functions as a chart manager 27a, a prescription support section 27b and an administration result entry section 27c. The HDD 29 is a well-known data storage device which stores the control program, the electronic chart program and various data to run these programs. The memory 28 is a working memory for the CPU 27 to run the programs. The CPU 27 loads the programs from the HDD 29 to the memory 28 to run the programs.

The console 26 consists of a monitor 26a displaying an operation screen and the medical chart data and input devices such as a keyboard 26b and a not-shown mouse for inputting data and operation commands. The LAN interface 30 controls communication according to a communication protocol of the LAN 22. The CPU 27 carries out display control of a display screen on the monitor 26a and reception control of data and commands as being input through the input devices.

The chart manager 27a receives the input of medical records input through a chart input screen displayed on the monitor 26a, creates the medical chart data based on the received medical records, and stores the created data in the chart data storage 23a. The medical records include a diagnosis such as patient's indication, information on inspection and diagnosed names of disease, and a prescription indicating medicines prescribed according to the diagnosis. The chart manager 27a reads out the medical chart data from the chart data storage 23a based on a search criterion such as a patient name or a patient ID, to display the medical chart data on the monitor 26a. When update of the medical chart data is demanded, the demand is received and an updating process is performed.

The prescription support section 27b accesses the drug information storage 23b based on some search criteria to take out the drug information that meets the search criteria, and displays the drug information on the monitor 26a. For example, the prescription support section 27b receives data of a diagnosed disease and indication of a patient as the search criteria and searches the drug information storage 23b for such drug information that meets the search criteria.

The administration result entry section 27c receives the results of administration input through the console 26, to record and store the results of administration in the administration result storage 23c. The administration result entry section 27c also sends the result of administration to the drug information collecting system 12 through the communication network 19 to upload the result of administration onto the collected information DB 17.

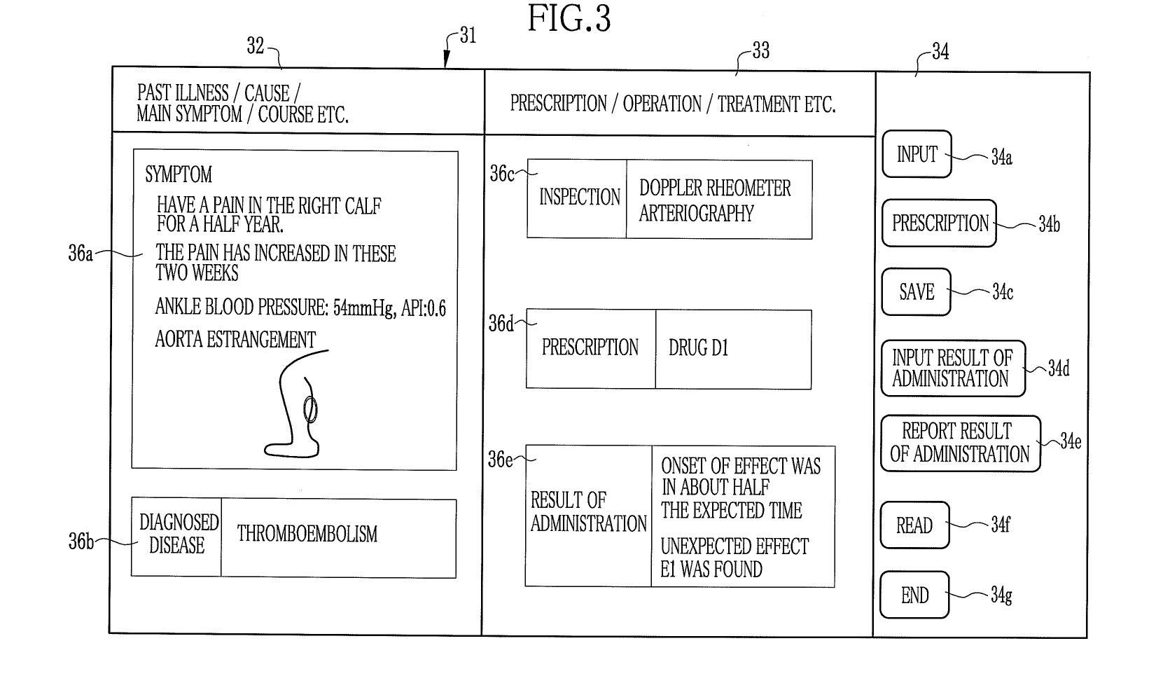

FIG. 3 illustrates an example of a chart input screen 31, which accepts the medical records as input through the console 26 and displays the input contents as a chart. The chart input screen 31 is mainly divided into two areas: a first area 32 displaying a past illness, major symptom, course, etc., and a second area 33 displaying records of prescription, medical operation, treatment, etc. Moreover, an operation panel 34 displaying operation buttons is provided next to the second area 33.

On the operation panel 34, an input button 34a, a prescription button 34b, a save button 34c, an administration result input button 34d, an administration result report button 34e, a reading button 34f and an end button 34g are arranged. The input button 34a is for inputting data. By clicking the input button 34a with the mouse or the like, data entry boxes 36a, 36b, 36c, 36d, 36e where data is to be input are displayed. Upon making the first area 32 active and clicking the input button 34a, the data entry boxes 36a to 36e open in the first area 32. Upon making the second area 33 active and clicking the input button 34a, the data entry boxes 36a to 36ez open in the second area 33. Through the keyboard, the data is written into the data entry boxes 36. In this way, various data items including patient's indication, results of examinations, diagnosed diseases, information on adopted inspections, prescribed contents and results of administration are input. The save button 34c is for entering a command to store the input data, upon which, the input data is stored in the chart data storage 23a.

The reading button 34f is for giving a command to read out the medical chart data from the chart data storage 23a. Clicking the reading button 34f displays a box for inputting criteria for specifying the medical chart data. Inputting a patient name and ID in this box specifies the desired medical chart data. The end button 34g is for ending the input of the medical chart data. Upon clicking the end button 34g, the chart input screen 31 closes.

The prescription button 34b is for executing a prescription support process to search for available drugs. Upon clicking the prescription button 34b, the prescription support section 27b searches for available drugs for prescription based on the input name of the diagnosed disease.

The administration result input button 34d is for inputting such results of administration that were unexpected at the time the drugs were approved, whereas expected results of administration are input with the use of the input button 34a and are recorded as the medical chart data along with other items in the chart data storage 23a. The administration result input button 34d is used for inputting information to be reported to the data center 11. The results of administration input through the administration result input button 34d are received in the administration result entry section 27c and recorded in the administration result storage 23c as well as in the chart data storage 23a as the medical chart data.

The administration result report button 34e is for giving a command to the information in the administration result storage 23c to the data center 11. Upon giving the command with the administration result report button 34e, unsent results of administration in the administration result storage 23c are sent to the data center 11.

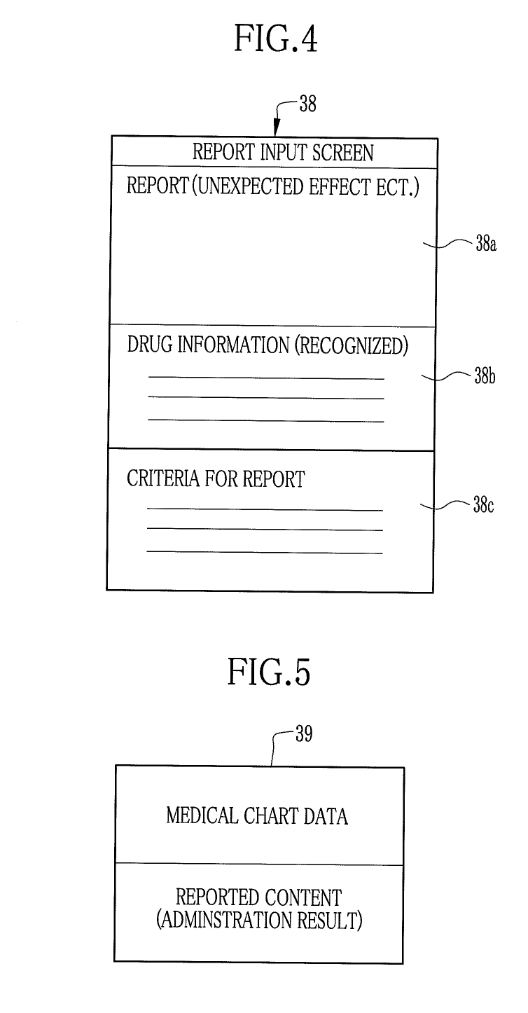

Upon clicking the administration result input button 34d, the administration result entry section 27c displays for example a report input screen 38 shown in FIG. 4. The report input screen 38 is provided with a report contents entry field 38a for inputting information on probably unexpected new results and side-effects, a drug information field 38b for displaying such drug information on a prescribed drug D1 that has been recognized by the approval authorities 18, and a report criteria field 38c.

The drug information field 38b displays the drug information that the administration result entry section 27c reads out according to the name of the prescribed drug from the drug information storage 23b. The drug information includes the recognized results and side-effects of the named drug.

The report criteria field 38c displays predetermined criteria for judging whether the information should be reported to the data center 11 or not. Predetermining the judgmental criteria is ensuring the quality of reported information to a certain degree. The decision as to whether to report the result of administration or not is finally made by the doctors. It is expected, however, that setting some given judgmental criteria for deciding on whether to report or not reduces the variations in the quality of the reported information and keeps out such information that is apparently not worth reporting. Displaying the judgmental criteria on the report input screen 38 makes it easy for the doctors to judge the adequacy of the information to be reported.

The judgmental criteria are for example “whether there are more than given numbers of similar cases reporting similar results of administration to the case in question?”, or “whether the ratio between cases where the reporting results of administration were seen and ones where the reporting results of administration were not seen is more than a given level among the plural cases where the same drugs were dosed as the case in question?”. The report criteria also show standards for such contents that should be reported, e.g. a case where the time from administration of a drug to appearance of its effect was extremely shorter than originally intended, a case where a dosed drug was found effective to cure other diseases and indications as well as the intended diseases and indications, or a case where the same diseases occurred on plural organs and the dosed drug took effect on other organs beside the intended organ. Obviously, the report contents include not only these good results but also different side-effects from the expected ones.

The administration result entry section 27c records the input report contents in the administration result storage 23c, linking them with the patient's medical chart data. For example the patient ID or the like is used for linking. When the administration result report button 34e gives a command of reporting, the administration result entry section 27c gets the results of administration stored in the administration result storage 23c and the linked medical chart data together to send them as the report data 39 to the data center 11. Because the sent medical chart data and results of administration are united, it is easier for the data center 11 to examine the report contents. As the medical chart data includes personal information, however, the administration result entry section 27c eliminates such information that specifies an individual person such as a patient name, address or contact information while making the report data 39. When consent is obtained from the patient, however, it is possible to omit the elimination process of the personal information before sending to the data center 11.

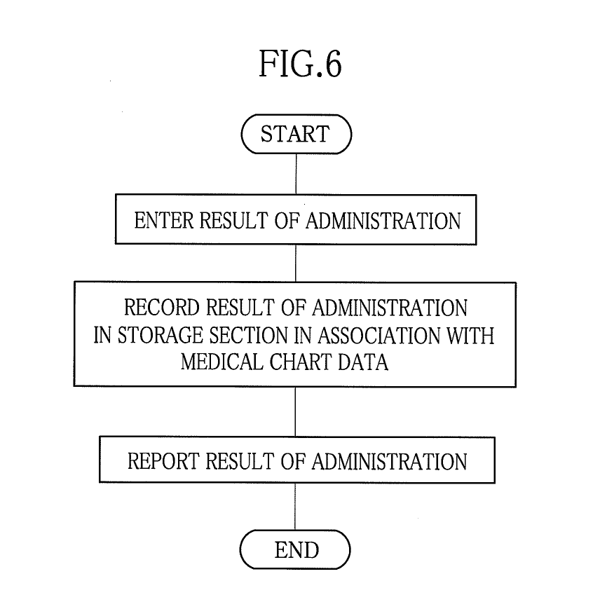

Now the operation of the above described embodiment will be explained while referring to a flowchart shown in FIG. 6. When inputting a patient's chart, a doctor starts to run the electronic chart program in the terminal apparatus 21 to display the chart input screen 31 on the console 26. The doctor inputs the medical records on the chart input screen 31. In addition, if unexpected effects, side-effects or results come from administration of prescribed drugs, the doctor reports it by inputting the contents on the report input screen 38 that appears upon clicking the administration result input button 34d.

As the already recognized information on the prescribed drugs and the judgmental criteria for the report are displayed on the report input screen 38, it is helpful for the doctor to make a decision as to whether the results of administration should be reported or not. The administration result entry section 27c records the input results of administration in the administration result storage 23c, in association with the medical chart data.

When uploading the input results of administration to the data center 11, the administration result report button 34e is clicked. Clicking the administration result report button 34e sends the data in the administration result storage 23c to the data center 11 to upload the data into the collected information DB 17. Because the terminal apparatus 21 in the electronic chart system 14 is provided with a function of reporting the results of administration, it is possible to report the results of administration easily and swiftly.

The data center 11 scrutinizes the collected information from such medical facilities as the hospitals 13. As the report includes the medical chart data, it is useful to examine cause-and-effect relationships between the drug and the reported contents about the drug. Based on the report, such contents that need to be recognized or authorized by the approval authorities 18 are submitted to the approval authorities 18. After being recognized by the approval authorities 18, the reported contents are stored as recognized information in the recognized information DB 16, and delivered to the respective medical facilities.

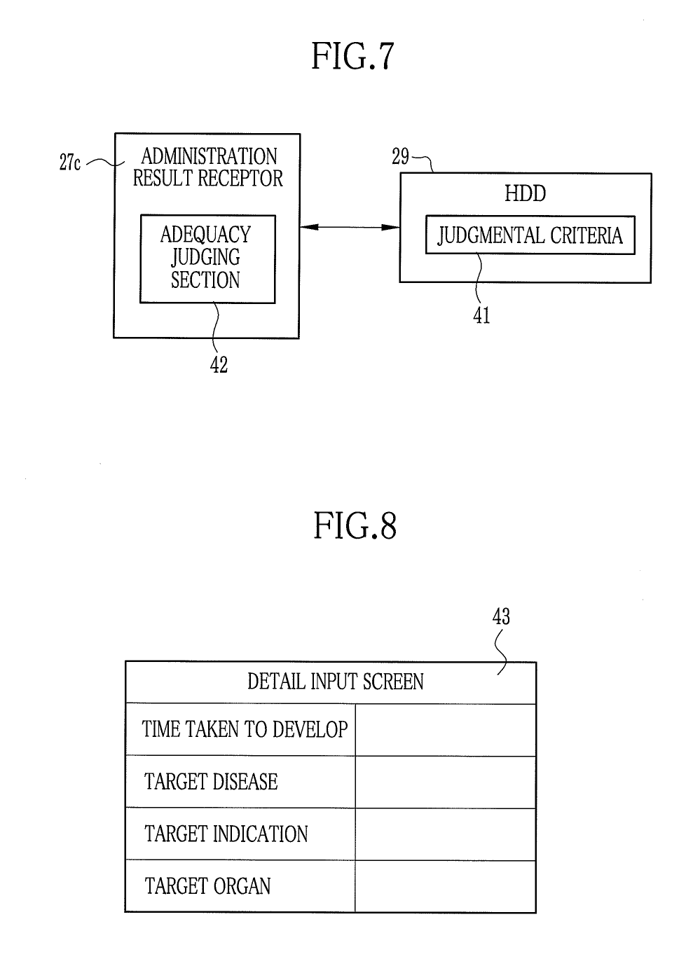

In the above described embodiment, the decision as to whether the result of administration should be reported to the data center 11 is left to the doctor. It is alternatively possible that the terminal apparatus 21 executes the judging process for the decision in place of the doctors. In this case, as shown in FIG. 7, data of judgmental criteria 41 as mentioned above is previously stored in the HDD 29 and the administration result entry section 27c is provided with an adequacy judging section 42 where the judging process is executed. In order to input data of the report in such a manner that the adequacy judging section 42 easily executes the judging process on the input data, it is possible to display a detail entry screen 43, as shown in FIG. 8. Through the detail entry screen 43, details of the reports are inputted and sorted into respective items, including the time taken to develop the effect, i.e. the time taken from the administration of the drug to the outset of its effect, target diseases, target indications and target circumstances.

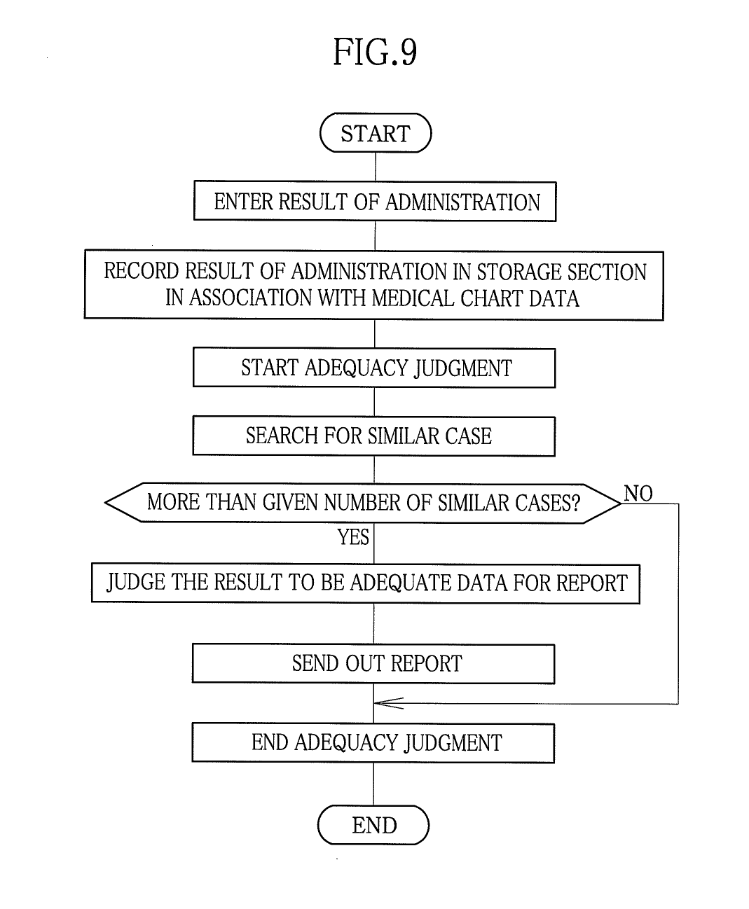

As shown in FIG. 9, the administration result entry section 27c receives the input of the results of administration through the detail entry screen 43 and then records the received results of administration in the administration result storage 23c, linking the results with the medical chart data. The adequacy judging section 42 starts to judge the adequacy of the received result of administration. The adequacy judging section 42 searches the administration result storage 23c and the chart data storage 23a to judge whether the received result of administration should be reported or not based on the search result. For example, when the search result shows that there are more than a given number of similar cases, e.g. more than three similar cases, the received result of administration is judged to be adequate for the report. When being judged to be adequate, the result of administration is sent to the data center 11 along with the related medical chart data in the end of the adequacy judgment. When the received result of administration is judged to inadequate, the adequacy judgment ends without sending the result of administration to the data center 11.

Because the terminal apparatus 21 automatically carries out complicated processes such as the search for the similar cases, work burden for the doctor is more reduced. Even if the result of administration is judged to be inadequate for the report at the time the result comes out, any of the received result of administration is stored in the administration result storage 23c, so that it can serve as a past example next time a similar case occurs. Therefore, even in such a case where the doctor is not sure about whether the result of administration should be reported or not, the result of administration can become useful data in the future, and this fact will motivate the doctor to input the result of administration without hesitation, promoting accumulation of data on any results of administration of the drugs. Providing good environment this way contributes to early discovery of such drug information that is initially unexpected, which is an important effect of the present invention.

In the above embodiment, the adequacy judging section 42 judges the result of administration to be adequate for the report when more than a given number of similar cases have already occurred. However, the judging process is not limited to this. It is possible to modify the judgmental criteria appropriately, for example, in the way as described above.

Although the electronic chart apparatus of the present invention has been described with respect to the electronic chart system consisting of the terminal apparatuses and the common DB in the above described embodiment, the electronic chart apparatus of the invention can be constituted of a terminal equipment and a storage section for storing the results of administration. In the above described embodiment, the plural terminal apparatuses are connected to the common DB through the LAN. Instead, the data may be stored in a storage device inside the respective terminal apparatuses, without connecting the terminal apparatuses to the database. Obviously, the present invention includes program forms as shown in the above described embodiment.

Thus, the present invention is not to be limited to the above embodiments but, on the contrary, various modifications will be possible without departing from the scope of claims appended hereto.

What is claimed is:

1. A network system for collecting drug information, comprising:
a drug information collecting apparatus;
at least an electronic chart apparatus for computerizing and managing medical charts of patients; and
a communication network connecting said electronic chart apparatus to said drug information collecting apparatus, said electronic chart apparatus comprising an administration result entry device for entering results of administration of prescribed drugs in the medical charts, wherein such results of administration of the prescribed drugs that were unexpected when the prescribed drugs were approved are sent from said administration result entry device to said drug information collecting apparatus through said communication network, in association with the medical charts of the respective patients who get the unexpected administration results.

2. An electronic chart apparatus for computerizing and managing medical charts of patients, said electronic chart apparatus comprising:
a communication device for sending data to an external drug information collecting apparatus through a communication network; and
an administration result entry device for entering results of administration of prescribed drugs in the medical charts, wherein such results of administration of the prescribed drugs that were unexpected when the prescribed drugs were approved are sent from said administration result entry device to said drug information collecting apparatus through said communication device, in association with the medical charts of respective patients who get the unexpected administration results.

3. An electronic chart apparatus as recited in claim 2, further comprising:
a storage device for storing and accumulating the unexpected results of administration of the prescribed drugs as entered through said administration result entry device;
a search device for searching said storage device for similar cases to an unexpected result of administration; and
a judging device for judging based on data obtained by said search device whether the unexpected result of administration should be sent to said drug information collecting apparatus.

4. An electronic chart apparatus as recited in claim 3, wherein said judging device judges that the unexpected result of administration should be sent to said drug information collecting apparatus if said search device retrieves more than a given number of similar cases from said storage device.

5. An electronic chart apparatus as recited in claim 3, wherein said storage device stores the unexpected results of administration in association with the medical charts of the respective patients who get the unexpected administration results.

6. An electronic chart apparatus as recited in claim 2, further comprising a display device for displaying criteria for judgment as to whether the unexpected result of administration should be sent to said drug information collecting apparatus, so that the unexpected results of administration are sent to said drug information collecting apparatus only when it is judged to be necessary.

7. An electronic chart apparatus as recited in claim 2, wherein said electronic chart apparatus may refer to information collected in said drug information collecting apparatus through said communication device.
